(19) United States
(12) Patent Application Publication
(10) Pub. No.: US 2004/0151303 A1
(43) Pub. Date: Aug. 5, 2004

(54) Apparatus and method for enhancing speech quality in digital communications

(76) Inventors: Ho Chong Park, Sungnam-si (KR); Seoung Jun Oh, Namyangjoo-si (KR); Jong Beom Hwang, Sungnam-si (KR)

Correspondence Address: Law Offices, Jacobson Holman, Professional Limited Liability Company, 400 Seventh Street, N.W., Washington, DC, 20004-2218, US

(21) Appl. No.: 10/716,162

(22) Filed: Nov. 19, 2003

(30) Foreign Application Priority Data
Nov. 19, 2002 (KR) 10-2002-71928

(51) Int. Cl. H04M 9/08

(52) U.S. Cl. 379/406.01

(57) ABSTRACT

An apparatus and method for enhancing speech quality in digital communications. In the speech-quality enhancing apparatus, an input buffer stores a sum signal of a first input signal to be transmitted and an echo signal generated from a received second input signal at a predetermined time interval. An echo canceller receives the sum signal based on a unit of a buffer from the input buffer, cancels the echo signal from the sum signal, and outputs the first input signal. A noise canceller receives the first input signal based on the buffer unit from the echo canceller, and cancels a noise from the first input signal. A level controller receives the first input signal based on the buffer unit from the noise canceller, and adjusts a level of the first input signal. A speech compression module receives the first input signal based on the buffer unit from the level controller, converts the first input signal into a digital signal, and compresses the digital signal. Various information items produced as results of operations can be shared, and operation performances can be enhanced on the basis of the shared information items.

### BACKGROUND OF THE INVENTION

1. Field of the Invention

The present invention relates to an apparatus and method for enhancing speech quality in packet-based digital communications, and more particularly to an apparatus and method for enhancing speech quality in packet-based digital communications, which can organically integrate, into a single unit, an echo canceller, noise canceller, level controller and speech codec for enhancing the speech quality of digital communications, and maximize and simply implement performance of enhancing the speech quality.

2. Description of the Related Art

As PSTN(Public Switched Telephone Network)-based communications develop into packet-based digital communications representing digital mobile communications and Internet communications, the most important factor in the packet-based digital communications is to ensure high speech quality.

However, a packet network is inappropriate for real-time two-way voice communications as compared with the conventional PSTN. Furthermore, the packet network can cause a new quality degradation factor due to various processing operations for the digital communications. As basic communication architecture is changed, new problems not occurred in PSTN-based communications may occur. Thus, voice communication quality can be seriously degraded due to the new problems.

Representative problems in the packet-based voice communications include a signal coding error, a data transfer error, a transfer delay and a change of a transfer delay time. The above-described problems are not specific problems in the voice communications, but can seriously degrade the speech quality in relation to characteristics of the voice communications.

Further, the voice communications through mobile terminals may be often performed in a noisy environment, and an ambient noise that is no problem in the conventional PSTN can seriously degrade speech quality due to a speech coding operation based on a low transmission rate in mobile communications.

As new factors that are no problem in the conventional PSTN degrade the speech quality in the packet-based voice communications, the new problems must be solved so that high-quality digital communication services can be appropriately provided. Representative factors seriously affecting the speech quality in the packet-based digital communications are as follows.

(1) Packet Error

A packet error represents a bit error and packet loss occurring in a speech-packet transfer operation. The packet error depends upon a propagation environment, demodulator performance, power control performance, error correction method, RF (Radio Frequency) module performance, cell design, etc. in the mobile communications. Further, the packet error depends upon a network connection, traffic load, error correction method, etc. associated with wired systems.

(2) Packet Transfer Delay

A packet transfer time indicates a time period required for transferring a speech packet to a target destination. A packet transfer delay includes a coding delay in a signal coding process, a delay in a packetizing process, a jitter delay, a transfer delay, etc. The packet transfer delay depends upon a speech coder, network design, buffer management method, etc.

(3) Jitter

Jitter is associated with a change of a transfer delay time required for transferring each packet in a packet communication network. The jitter can cause a total transfer delay time and the number of lost packets to be increased.

(4) Speech Coding

Where information is lost in a procedure of coding a speech signal into digital data, speech quality can be degraded. The speech coding operation depends upon a compression method and compression rate.

(5) Echo Signal

The echo signal indicates a signal reflected back to a source of the signal in a procedure of transferring a speech signal in two-way voice communications. There are a hybrid echo signal in a PSTN switch and an acoustic echo signal in a terminal as the echo signal. A degree of signal distortion due to the echo signal depends upon an echo signal level and transfer delay time. The echo signal has no problem in a telephone of PSTN having a relatively short transfer time. As the transfer delay time increases in the digital communications, the echo signal is a new factor, resulting in degrading the speech quality.

(6) Speech Signal Level

Where an inappropriate speech signal level degrades the performance of a speech coder, a speech signal is distorted and the overall speech quality is degraded. A telephone of the conventional PSTN not performing an operation of the speech coder has no problem in terms of the speech signal level because only a volume level is increased or decreased in the conventional PSTN-based telephone.

(7) Ambient Noise

Characteristics of a speech coder vary with the ambient noise, and hence speech quality is degraded. A conventional PSTN-based telephone not performing an operation of the speech coder has no problem in terms of the ambient noise.

The (1), (2) and (3) factors among the above-described factors deciding the speech quality are problems associated with an information transfer. In other words, the (1), (2) and (3) factors are the problems occurring when error-free information cannot be transferred at a correct point of time without a delay. Accordingly, the problems must be researched in relation to a network. In particular, these problems do not correspond to specific problems in voice communications, but correspond to the important problems associated with the digital communications.

However, the above described (4), (5), (6) and (7) factors correspond to specific problems in the digital voice communications. A speech signal itself to be transferred is distorted in relation to the above described (4), (5), (6) and (7) factors and hence the speech quality is degraded. To address problems associated with the above described (4), (5), (6) and (7) factors, the speech signal must be directly and appropriately processed.

Because the speech coder must follow a standard for the digital voice communications, a speech coding method of the speech coder is difficult to change. Although predetermined compatibility associated with the speech coder is maintained and the performance of the speech coder is enhanced, its advantageous effect is very limited.

That is, factors associated with the problems capable of being addressed using new techniques for processing speech signals are the (5), (6) and (7) factors. If the problems associated with the (5), (6) and (7) factors are addressed using the new techniques, it is expected that the speech quality can be effectively enhanced.

The techniques for resolving the problems associated with the above described (5), (6) and (7) factors have been researched for a long time, related devices have been developed, and the developed devices have been applied to a system. However, each of the devices for resolving the problems has been independently developed, and has been designed based on generalized architectures regardless of systems to be applied to.

When the devices are developed through the generalized design, each device can be developed irrespective of an applicable system and can be applied without being limited by various systems. However, as each device is independently designed and is independently applied to the system, there are problems in that the relationship between an echo cancellation operation, noise cancellation operation and level adjustment operation cannot be utilized, operations linked to the speech coder cannot be appropriately performed, and the operations must be limited and repeated.

Conventional independent devices for addressing the three problems associated with the above described (5), (6) and (7) factors are as follows.

FIG. 1 is a block diagram illustrating the structure of a conventional echo canceller 10 using an adaptive filter technique. Referring to FIG. 1, the conventional echo canceller 10 includes an adaptive filter 106, a DT (Double-Talk) detector 109 and a non-linear processor 110. When two talkers communicate with each other through communication systems, a corresponding communication system for each talker performs a function of canceling an echo signal, for example, in a switch or terminal.

An operation of the conventional echo canceller 10 where it is assumed that remote user A and local user B communicate with each other will be described. Basic two-way communication is performed between the users A and B. The remote user A sends a speech signal 101 to the user B so that the user B can hear the speech signal 101. The user B sends a speech signal 104 to the remote user A.

An echo generator (associated with a hybrid path of a PSTN switch or an acoustic path between a microphone and speaker for a terminal) generates an echo signal 103 from the speech signal 101 from the user A. The echo signal 103 is combined with the speech signal 104 and hence a sum signal 102 is sent to the user A.

The echo canceller 10 receives the sum signal 102 in which the echo signal 103 and the speech signal 104 are summed. Then, the echo canceller 10 cancels the echo signal 103 associated with the speech signal of the user A from the sum signal 102. As a result, the echo canceller 10 produces its output signal 105.

The user B's speech signal 104 must be able to be correctly sent to the user A without being affected by the echo signal 103 contained in the sum signal 102. In other words, where the echo canceller 10 is ideal, the output signal 105 of the echo canceller 10 is the same as the speech signal 104 of the user B.

A structure and operation of the echo canceller 10 will be described in detail. The adaptive filter 106 performs a function of predicting the echo signal 103 using the speech signal 101 of the user A. The adaptive filter 106 outputs a predicted echo signal 107 using a digital adaptive filter technology. As an adaptive algorithm for canceling the echo signal, an NLMS (Normalized Least Mean Square) algorithm is mainly used.

The echo canceller 10 subtracts the predicted echo signal 107, outputted by the adaptive filter 106, from the sum signal 102, thereby producing a signal 108 in which the echo signal is cancelled. The detailed structure of the adaptive filter 106 is appropriately designed according to a delay time between the speech signal 101 from the user A and the echo signal 103, target performance, complexity of calculation, etc.

The DT detector 109 detects a point of time when the two users A and B simultaneously talk. In other words, the DT detector 109 determines whether the speech signal 101 of the user A and the speech signal 104 of the user B are simultaneously inputted. At this time, since the DT detector 109 cannot directly receive the speech signal 104 of the user B, the DT detector 109 estimates the existence of the speech signal 104 of the user B from the sum signal 102.

The DT detector 109 analyzes a correlation between the speech signal voiced by the user A and the sum signal 102, and additionally analyzes the predicted echo signal 107 and the signal 108 in which the echo signal is cancelled, such that the DT detector 109 finally detects a double talk. If it is determined that the speech signal 101 of the user A and the speech signal 104 of the user B simultaneously exist, the adaptive filter 106 stops an operation of updating its coefficients.

The non-linear processor 110 finally cancels the echo signal 103 remaining in the signal 108 due to an incomplete operation of the adaptive filter 106. If it is determined that the speech signal 104 of the user B is not inputted, the non-linear processor 110 cuts off the signal 108, and performs an operation of inserting a relatively low-level white noise so that the user A cannot hear the relatively small echo signal 103 contained in the signal 108.

However, since the non-linear processor 110 must transfer the speech signal 104 of the user B without any signal distortion if it is determined that the speech signal 104 of the user B exists, the non-linear processor 110 must stop the signal cut-off operation. As described above, the echo canceller 10 simultaneously analyzes various signals and performs an optimized operation according to a result of the analysis. In particular, the echo canceller 10 performs the important function of determining whether or not the speech signal 101 of the user A and the speech signal 104 of the user B are inputted.

The conventional echo canceller 10 carries out an echo cancellation operation in units of signal samples. In other words, if the speech signal of the user A and the sum signal 102 corresponding to one sample are inputted, the echo canceller 10 carries out the echo cancellation operation by synthesizing sample values and previous information, such that the output signal 105 for the one sample is produced. The conventional echo canceller 10 cannot use information to be subsequently inputted and hence only limited information can be used.

If the information of the input signal to be subsequently inputted is desired to be used, an input unit for the speech signal 101 of the user A and the sum signal 102 must include a storage buffer for storing the signals so that the stored signals can be processed. In this case, there are problems in that a delay time occurs in a procedure of transferring the speech signal 104 of the user B as the output signal 105 and hence a total communication delay time is increased. Further, an error in determining whether or not a user's speech is inputted must be minimized so that the echo canceller 10 can stably operate. At this time, more complex analysis operations for many available signals must be carried out.

The conventional echo canceller 10 shown in FIG. 1 can be globally used. However, the conventional echo canceller 10 cannot have the maximum performance due to the transfer delay limitation. Furthermore, since the conventional echo canceller 10 requires an additional transfer delay and an increased amount of calculation to improve its performance, it is difficult for the performance of the echo canceller to be effectively implemented.

FIG. 2 is a block diagram illustrating the structure of a conventional noise canceller 20 using a frequency subtraction method. Referring to FIG. 2, the conventional noise canceller 20 using the frequency subtraction method includes a frequency domain converter 203, a band splitter 205, a band-by-band noise estimator 206, a noise component subtracter 207 and a time domain converter 208. The conventional noise canceller 20 receives an input signal 201 composed of a sum of a speech signal and a noise signal, and then cancels the noise signal from the input signal 201 to produce an output signal 202 in which the noise signal is cancelled.

The frequency domain converter 203 (e.g. a Fourier conversion processor) receives the input signal 201 and converts the received input signal 201 into a frequency component signal 204. The band splitter 205 divides the frequency component signal 204 on the basis of constant frequency bands.

The band-by-band noise estimator 206 analyzes the input signal 201 and the frequency component signal 204 and estimates noise components on a frequency band-by-band basis. The noise component subtracter 207 subtracts the estimated noise components from the frequency component signal 204 so that the noise components can be cancelled from the input signal 201. As a result, the noise component subtracter 207 produces a speech signal in which the noise components are cancelled in a frequency domain.

The time domain converter 208 converts the speech signal of the frequency domain into a speech signal 202 of a time domain. In this case, an operation of predicting the noise components is carried out by analyzing components on a frequency band-by-band basis when the input signal 201 contains no speech signal.

The noise canceller 20 needs to determine whether or not the speech signal is contained in the input signal 201 as in the above-described operation of the echo canceller 10. When the noise component subtracter 207 removes the noise components on a frequency band-by-band basis, the speech signal's characteristics must be considered so that better performance can be acquired. Since many mathematical analyses are required in terms of the speech signal associated with the input signal 201, it is difficult for the noise canceller 20 having better performance thereof to be independently implemented.

A subtraction operation and an operation of deciding an amount of subtraction carried out by the noise component subtracter 207, a noise estimation method carried out by the band-by-band noise estimator 206, and design and implementation methods for other elements are different according to applicable fields and usage technologies. The noise canceller 20 can be implemented by other methods as well as the frequency subtraction method.

FIG. 3 is a block diagram illustrating the structure of a conventional level controller 30. Referring to FIG. 3, the conventional level controller 30 includes a level estimator 302, a level conversion decider 303 and a level converter 304. The level controller 30 appropriately adjusts a level of an input signal 301.

The level estimator 302 analyzes the input signal 301 and then estimates a signal level. The level conversion decider 303 decides a conversion level using the estimated signal level. The level converter 304 converts the level of the input signal 301 into the level decided by the level conversion decider 303, thereby producing a final output signal 305.

The level estimator 302 measures only a level of the speech signal contained in the input signal 301 rather than an entire level of the input signal 301. The level estimator 302 carries out an operation of adjusting only the speech signal level. This is advantageous in terms of performance enhancement of the level controller 30. Therefore, the level estimator 302 must perform a function of determining whether or not the speech signal exists. Further, a noise must be cancelled before the signal level is converted so that the performance of the level controller 30 can be enhanced. For this reason, the level converter 304 must perform a function of canceling the noise. Where the performance enhancement of the level controller 30 is independently accomplished, there is a problem in that the level controller 30 must repeatedly implement functions performed by the echo canceller 10 and the noise canceller 20.

FIG. 4 is a block diagram illustrating the structure of a conventional speech codec 40 based on CELP (Code Excited Linear Prediction). Referring to FIG. 4, the CELP-based speech codec 40 includes a speech compressor 41 and a speech decompressor 42. The CELP-based speech codec 40 is widely used for current digital communications.

The speech compressor 41 converts a speech signal into a digital code, and includes an input buffer 402 and a speech compression module 43. An input speech signal 401 is stored in the input buffer 402 every 20 msec, for example. The speech compression module 43 carries out a speech compression operation every 20 msec.

The speech compression module 43 includes an LPC (Linear Prediction Coding) analyzer 403, a pitch analyzer 404, a codebook analyzer 405 and a packetizer 406.

The LPC analyzer 403 extracts LPC information 421 associated with the speech signal from a signal 420 stored in the input buffer 402. The pitch analyzer 404 produces pitch information associated with the signal 420 stored in the input buffer 402. The codebook analyzer 405 acquires codebook information 423 using the signal 420 stored in the input buffer 402, LPC information 421 and pitch information 422. The packetizer 406 packetizes the LPC information 421, the pitch information 422 and the codebook information 423 and then generates a speech packet 407, such that the speech compression operation can be completed.

The speech decompressor 42 decompresses a speech packet to a speech signal, and includes an output buffer 413 and a speech decompression module 44. The speech decompressor 42 performs a speech decompression operation opposite to the speech compression operation of the speech compressor 41. A de-packetizer 409 of the speech decompression module 44 de-packetizes a received speech packet 408 and then acquires necessary information items, i.e., codebook information 424, pitch information 425 and LPC information 426. A codebook synthesizer 410, a pitch synthesizer 411 and an LPC synthesizer 412 produce a recovered speech signal 427 using the codebook information 424, the pitch information 425 and the LPC information 426. The recovered speech signal 427 is stored in the output buffer 413. A size of the output buffer 413 is the same as a size of the input buffer 402 of the speech compressor 41. The Speech signal stored in the output buffer 413 is outputted in units of samples.

Here, the LPC information items 421 and 426, the pitch information items 422 and 425, and the codebook information items 423 and 424 are typically defined in the CELP-based speech codec. The LPC information items 421 and 426 indicate spectrum information items associated with the speech signal. The LPC information items 421 and 426 are typically expressed as 10 LPC filter coefficients, respectively. The pitch information items 422 and 425 indicate characteristics of periodic speech signals, and are expressed as a pitch period and a pitch gain, respectively. The codebook information items 423 and 424 correspond to excitation signals necessary for speech synthesis, and are expressed as a codebook index and a codebook gain, respectively.

In the LPC analysis operation, pitch analysis operation and codebook analysis operation performed in the CELP-based speech compression procedure, a parameter quantization error is calculated, and an error between an original signal and a recovered signal is calculated so that the speech compression performance can be measured. Information of the measured speech compression performance can be fed back for another signal processing operation that is performed before the speech compressor 41. On the basis of the fed back information, the signal processing operation can be automatically adjusted so that the speech compression performance can be improved.

Major characteristic information associated with the speech signal extracted by the speech compressor 41 can serve as information necessary for the operations of the echo canceller 10, the noise canceller 20 and the level controller 30. In the speech signal coding procedure, the input buffer 402 stores the speech signal every 20 msec, for example. Where the signal stored in the input buffer 402 is used for the operations of the echo canceller 10, the noise canceller 20 and the level controller 30, the operational performance of each device can be enhanced.

Further, the speech compressor 41 of a certain speech coder analyzes the signal 420 stored in the input buffer 402 and previous information and then determines the existence of the speech signal on the basis of a result of the analysis. If the speech signal is detected, communication is performed at a high transmission rate. Otherwise, communication is performed at a low transmission rate. On the basis of the existence of the speech signal, a signal can be transmitted at a variable transmission rate. If a result of the determination of the existence of the speech signal is used for the operations of the echo canceller 10, the noise canceller 20 and the level controller 30, the operational performance of each device can be improved.

Further, the speech codec 40 is organically coupled to other devices such as the echo canceller 10, the noise canceller 20, the level controller 30, etc. in order to enhance speech quality. Thus, the other devices need to share a buffer provided in the speech codec 40 and additional information generated in the operation of the speech codec 40.

However, the conventional speech codec 40 is developed and operated independently of the echo canceller 10, the noise canceller 20 and the level controller 30. Information generated as a result of the operation of the speech codec 40 is not shared. As the devices and the speech codec 40 repeatedly perform the same operation, there is a problem in that the optimized performance enhancement cannot be performed.

The conventional serial combination of the echo canceller 10, the noise canceller 20, the level controller 30 and the speech codec 40 are based on only a physical combination. In this case, a transfer delay according to consecutive operations can occur and related information items cannot be organically shared. Thus, a problem associated with a repeat operation cannot be addressed. Furthermore, an operation of enhancing speech quality cannot be effectively performed. Next, an example of a conventional apparatus will be described in detail.

FIG. 5 is a block diagram illustrating a structure of the conventional apparatus including an echo canceller 10, a noise canceller 20 and a level controller 30 to enhance speech quality in packet-based digital communications using a conventional speech codec 40. Where there are applied all speech quality enhancement functions associated with echo cancellation, noise cancellation, level adjustment, etc. in the packet-based digital communications using the conventional speech codec 40, independent devices for performing the above described functions are sequentially connected to each other as shown in FIG. 5. Order of device connections can be changed according to designs.

Referring to an operation of the conventional apparatus for enhancing the speech quality, the echo canceller 10 cancels an echo signal from a first input signal 102, thereby producing a signal 105 as a result of the echo cancellation. Then, the noise canceller 20 cancels a noise signal from the signal 105, thereby producing a signal 202 as a result of the noise cancellation. Then, the level controller 30 adjusts a level of the signal 202, thereby producing a signal 305 as a result of the level adjustment. Then, the speech compressor 41 contained in the speech codec 40 compresses the signal 305, thereby producing a signal 407. Further, an output signal of the speech decompressor 42 is inputted into the echo canceller 10, and endures the echo cancellation operation.

In the structure of the conventional apparatus, the respective devices are independently implemented, and coupled to each other through only input/output signals. Thus, the devices cannot share internal information in the structure of the conventional apparatus. Although it is possible for the devices to share the internal information, additional hardware is required and hence a transfer delay is increased.

The above-described three speech-quality degradation problems associated with the echo signal, speech signal level and noise all are closely associated with the speech signal. Since the performances of the respective devices are not completely independent of each other and are affected by each other, research on integrating the performances of the respective devices is seriously needed.

For example, the operation of the echo canceller 10 depends upon an input signal level and ambient noise level. The performance of the echo canceller 10 can be enhanced by an input signal analysis. The operation of the speech codec 40 can be different according to the speech signal level and ambient noise level, and hence a method for processing a packet error can be changed. Thus, if various items are integrated into one module to enhance speech quality, the integrated implementation can provide better performance as compared with the independent implementation.

As an integrated apparatus capable of enhancing the speech quality, a product into which the speech codec 40 and the noise canceller 20 are integrated has been developed. For example, there is a speech coder such as an IS-127 EVRC (Enhanced Variable-Rate Coder) The IS-127 EVRC includes a noise canceller, contained in a speech compressor, for canceling a noise from an input signal.

However, since the IS-127 EVRC does not provide a level adjustment function and echo cancellation function, the IS-127 EVRC additionally requires external devices for adjusting a signal level and canceling an echo signal. Thus, since the external devices operate independently of the IS-127 EVRC, it is difficult for the external devices and the IS-127 EVRC to be interworked.

In particular, where the noise canceller is located within the speech codec and the level controller is located outside the speech codec, there is a problem in that the signal level must be adjusted before the noise is cancelled, such that the optimum performance cannot be implemented. Furthermore, there is another problem in that hardware resources are wasted since the multiple devices do not share signal information items produced through many calculations.

As another integrated apparatus capable of enhancing the speech quality, a product into which the noise canceller 20 and the echo canceller 10 are integrated has been developed. However, the integrated echo and noise cancellers 10 and 20 cannot be integrated with the speech codec, and can operate for only a limited speech signal.

In this case, the integrated apparatus can be globally used, but cannot share many information items provided by the speech codec. In particular, a buffering function provided by the speech codec cannot be used, and only a speech signal having a very short duration can be used or an additional transfer delay occurs. Thus, there are other problems in that the above-described integrated apparatus for enhancing the speech quality cannot implement the optimum performance and wastes resources.

As described above, the conventional devices for enhancing the speech signal has the following problems.

First, the conventional devices are developed independently and appropriate for only the general structures. However, the conventional devices cannot be interworked and cannot sufficiently utilize a correlation between the devices. Thus, there is a problem in that the performances of the conventional devices are degraded.

Second, the conventional devices analyze the same input signal and its characteristics, and independently operate. There is another problem in that the efficiency of device implementation is degraded where the independent devices are connected to each other in series and then operate.

Third, the devices for enhancing the speech quality must have the minimum transfer delay to effectively perform two-way communications. However, since the conventional devices independently operate, each device has an independent transfer delay and a sum of independent transfer delays increase. For this reason, there is yet another problem in that a total transfer delay increases.

As a result, an improved apparatus and method for enhancing speech quality are seriously needed so that an echo canceller, noise canceller, level controller and speech codec can be organically integrated and operated.

### SUMMARY OF THE INVENTION

Therefore, the present invention has been made in view of the above problems, and it is one object of the present invention to provide an apparatus and method for enhancing speech quality in packet-based digital communications, which can use a correlation between operations associated with an echo canceller, noise canceller, level controller and speech codec that are implemented independently by organically integrating the echo canceller, noise canceller, level controller and speech codec into a single unit.

It is another object of the present invention to provide an apparatus and method for enhancing speech quality in packet-based digital communications, which can remove a repeat computation operation and use shared information by organically integrating an echo canceller, noise canceller, level controller and speech codec into a single unit.

It is yet another object of the present invention to provide an apparatus and method for enhancing speech quality in packet-based digital communications, which can reduce a transfer delay time without an additional transfer delay by organically integrating an echo canceller, noise canceller, level controller and speech codec into a single unit.

In accordance with one aspect of the present invention, the above and other objects can be accomplished by the provision of an apparatus for enhancing speech quality in digital communications, comprising: an input buffer for storing a sum signal of a first input signal to be transmitted and an echo signal generated from a received second input signal at a predetermined time interval; an echo canceller for receiving the sum signal based on a unit of a buffer from the input buffer, canceling the echo signal from the sum signal, and outputting the first input signal; a noise canceller for receiving the first input signal based on the buffer unit from the echo canceller, and canceling a noise from the first input signal; a level controller for receiving the first input signal based on the buffer unit from the noise canceller, and adjusting a level of the first input signal; and a speech compression module for receiving the first input signal based on the buffer unit from the level controller, converting the first input signal into a digital signal, and compressing the digital signal.

In accordance with another aspect of the present invention, there is provided a method for enhancing speech quality in digital communications, comprising the steps of: (a) storing a sum signal of a first input signal to be remotely transmitted and an echo signal generated from a remotely received second input signal at a predetermined time interval; (b) receiving the sum signal based on a unit of a buffer, canceling the echo signal from the sum signal, and extracting the first input signal; (c) receiving the first input signal based on the buffer unit, and canceling a noise from the first input signal; (d) receiving the first input signal based on the buffer unit in which the noise is cancelled, and adjusting a level of the first input signal; and (e) receiving the first input signal based on the buffer unit in which the level of the first input signal is adjusted, converting the first input signal into a digital signal, and compressing the digital signal.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating the structure of a conventional echo canceller using an adaptive filter technique;

FIG. 2 is a block diagram illustrating the structure of a conventional noise canceller using a frequency subtraction method;

FIG. 3 is a block diagram illustrating the structure of a conventional level controller;

FIG. 4 is a block diagram illustrating the structure of a conventional speech codec based on CELP (Code Excited Linear Prediction);

FIG. 5 is a block diagram illustrating the structure of a conventional apparatus including an echo canceller, noise canceller and level controller to enhance speech quality in packet-based digital communications using the conventional speech codec;

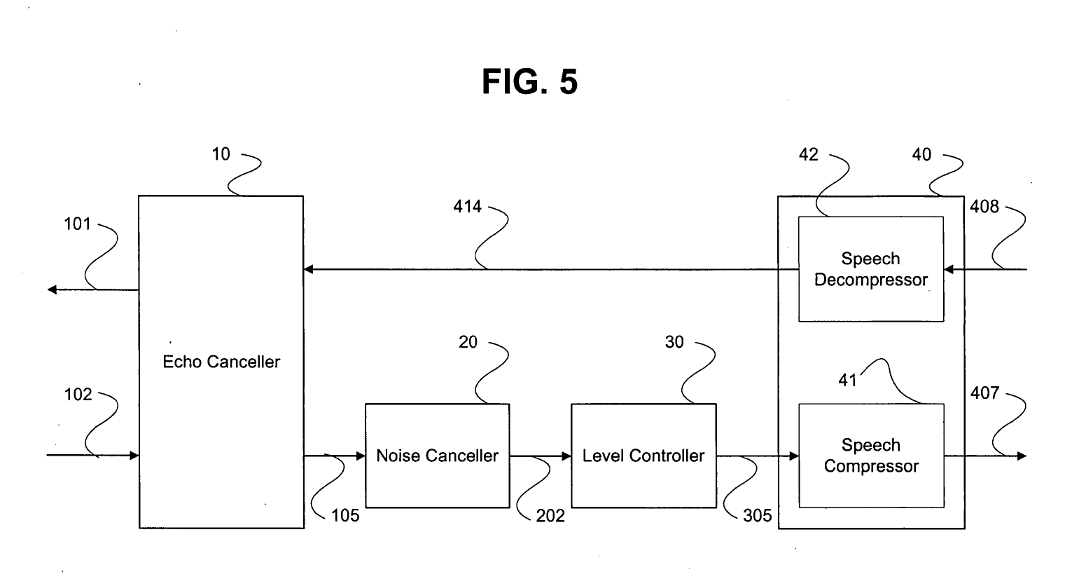

FIG. 6 is a block diagram illustrating the structure of an apparatus for enhancing speech quality in packet-based digital communications in accordance with one embodiment of the present invention;

FIG. 7 is a block diagram illustrating the detailed structure of an echo canceller contained in the speech-quality enhancing apparatus in accordance with the present invention;

FIG. 8 is a block diagram illustrating the detailed structure of a noise canceller contained in the speech-quality enhancing apparatus in accordance with the present invention; and

FIG. 9 is a block diagram illustrating the detailed structure of a level controller contained in the speech-quality enhancing apparatus in accordance with the present invention.

### DETAILED DESCRIPTION OF PREFFERRED EMBODIMENTS

An apparatus and method for enhancing speech quality in digital communications in accordance with preferred embodiments of the present invention will be described in detail with reference to the annexed drawings.

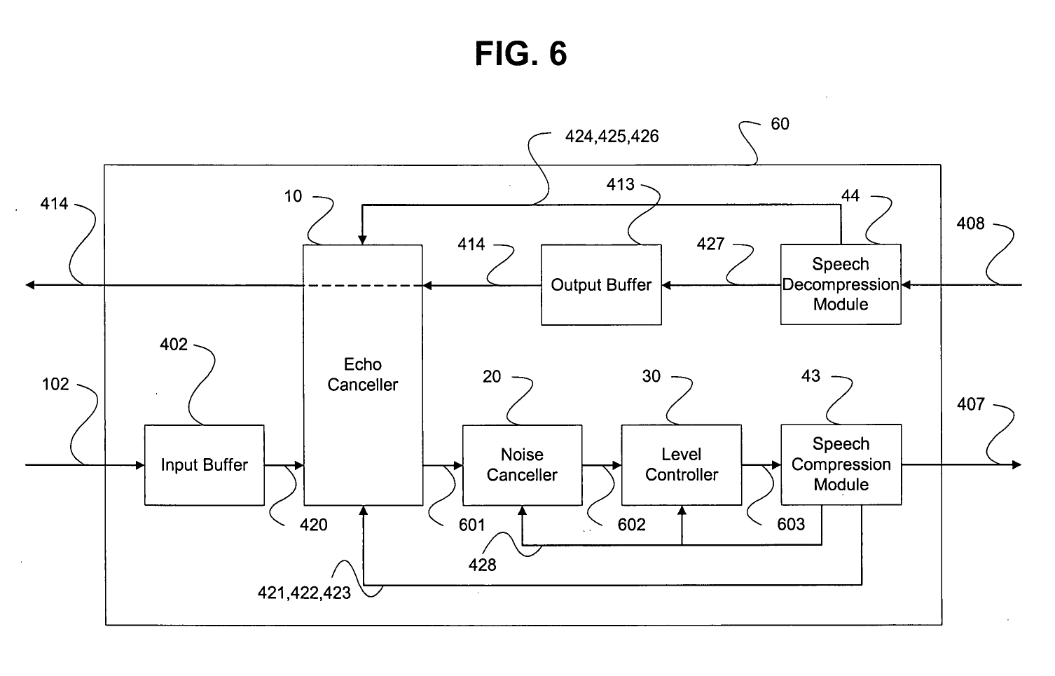

FIG. 6 is a block diagram illustrating the structure of an apparatus 60 for enhancing speech quality in packet-based digital communications in accordance with one embodiment of the present invention.

As shown in FIG. 6, the speech-quality enhancing apparatus 60 in accordance with the present invention includes a speech codec consisting of a speech compressor and speech decompressor, an echo canceller 10, a noise canceller 20 and a level controller 30, and organically integrates them into a single unit. The speech compressor includes a speech compression module 43 and an input buffer 402, and the speech decompressor includes a speech decompression module 44 and an output buffer 413.

In particular, the apparatus of the present invention is different from the conventional apparatus in that the speech compressor and decompressor together with other elements provided to enhance the speech quality can share information stored in the input buffer 402 and information stored in the output buffer 413. Thus, the elements of the speech-quality enhancing apparatus 60 can operate organically.

Here, the term “organically integrating” means that all operations are processed by one hardware processor (e.g., a global DSP (Digital Signal Processor) chip or ASIC (Application Specific Integrated Circuit)) or one operational unit, and that information can be freely exchanged between all elements, every operation is regarded as one operation, and the elements can be designed and implemented by one unit.

An operation of the speech-quality enhancing apparatus 60 in accordance with the embodiment of the present will be schematically described. An input signal 102 is a sum of a desired speech signal, inputted into the speech-quality enhancing apparatus 60, and an echo signal generated from an opposite side's speech in a two-way communication system.

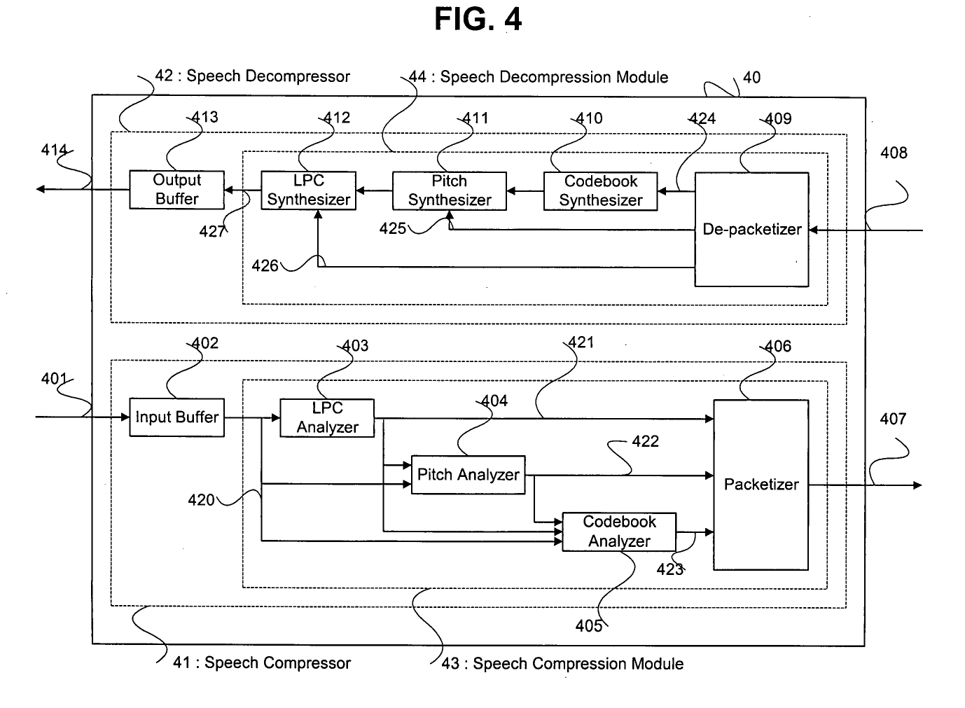

The echo and noise signals are cancelled from the input signal 102. Then, a speech signal level associated with the input signal 102 is appropriately adjusted. Then, a compression operation associated with the input signal 102 is carried out so that a speech packet 407 is produced. The speech packet 407 is transmitted to the opposite side so that voice communication can be performed. In this case, there are produced characteristic information items, associated with the input speech signal, containing LPC (Linear Prediction Coding) information 421, pitch information 422 and codebook information 423. Then, the speech compression performance is measured and then speech compression performance information 428 is generated. A method for measuring the speech compression-performance has been described in connection with FIG. 4.

A speech packet 408 received from the opposite side is inputted into the speech decompression module 44 internally contained in the speech-quality enhancing apparatus 60 in accordance with the present invention, and then the speech decompression module 44 decompresses the speech packet to output a speech signal 427. A recovered speech signal is finally outputted through the output buffer 413. In this procedure, the characteristic information items containing the LPC information 426, the pitch information 425 and the codebook information 424 are generated as byproducts of the speech signal remotely received from the opposite side.

A configuration and operation of the speech-quality enhancing apparatus 60 in accordance with the embodiment of the present invention will be described in detail with reference to FIG. 6. The input buffer 402 is a basic buffer provided in the speech compressor. The input buffer 402 typically stores a current input signal every 20 msec. A signal 420 is outputted from the input buffer 402 every 20 msec.

The signal 420 outputted from the input buffer 402 is provided to the echo canceller 10 once per 20 msec. In other words, the inventive apparatus 60 is different from the conventional apparatus in that the echo canceller 10 of the present invention receives an input signal stored in a unit of a buffer, while the conventional echo canceller 10 receives an input signal in a unit of a sample.

The echo canceller 10 receives the signal 420 stored in the input buffer 402 and a signal 414 stored in the output buffer 413. In response to the signals 414 and 420, the echo canceller 10 produces a signal 601 in which the echo signal is cancelled. At this time, the signal 601 in which the echo signal is cancelled becomes a signal based on the buffer unit that corresponds to a signal stored in the input buffer for 20 msec.

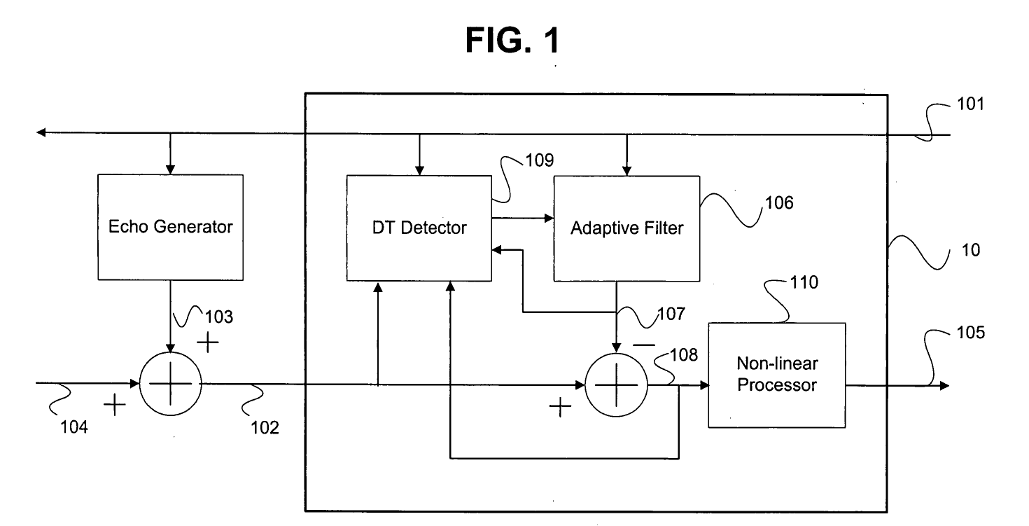

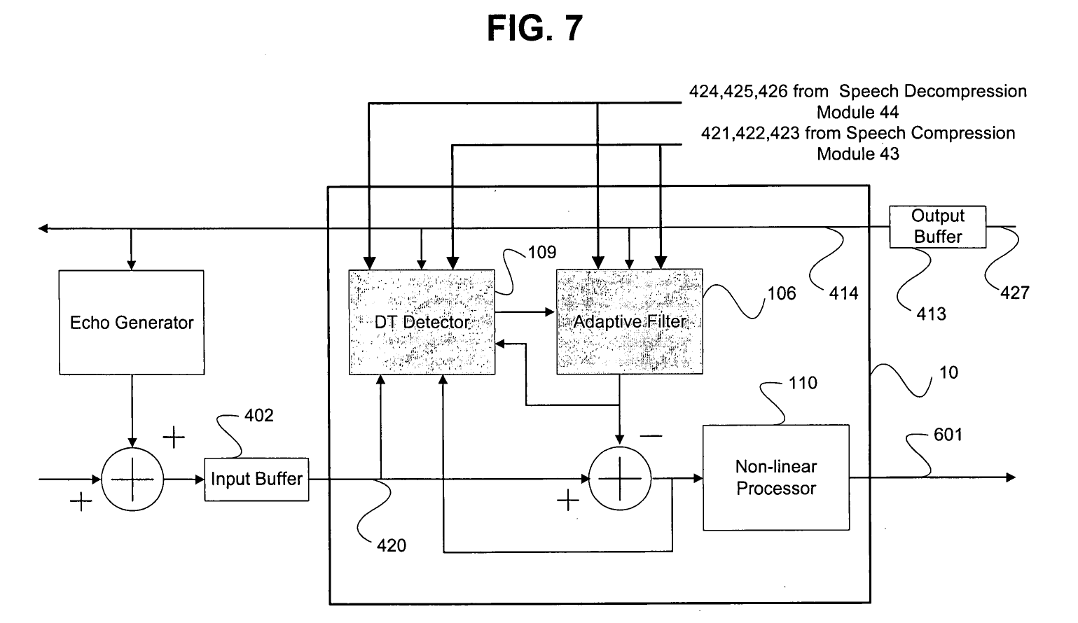

FIG. 7 is a block diagram illustrating a detailed structure of the echo canceller 10 contained in the speech-quality enhancing apparatus 60 in accordance with the present invention. When the echo canceller 10 of the present invention shown in FIG. 7 is compared with the conventional echo canceller 10 shown in FIG. 1, the conventional echo canceller 10 shown in FIG. 1 receives one sample containing the speech signal 101 of the remote user A and the sum signal 102 (corresponding to the sum of the echo signal generated from the speech signal of the user A and the speech signal of the user B) to carry out the echo cancellation operation and produce the signal 105, while the echo canceller 10 of the present invention shown in FIG. 7 simultaneously receives the input signal 420 outputted from the input buffer 402 and the input signal 414 outputted from the output buffer 413 to carry out the echo cancellation operation on the basis of the buffer unit and produce the output signal 601. Here, the input signals 414 and 420 correspond to multiple samples.

Thus, since the echo canceller 10 of the present invention carries out the echo cancellation operation on the basis of the input buffer 402, the performance of the echo canceller 10 of the present invention can be further enhanced as compared with that of the conventional echo canceller 10 that carries out the echo cancellation operation on the basis of one sample.

An adaptive filter 106 of the echo canceller 10 shown in FIG. 7 uses the conventional adaptive filter 106 shown in FIG. 1. In the speech-quality enhancing apparatus 60 in accordance with the present invention, the adaptive filter 106 can operate on the basis of the input buffer 402 provided in the present invention. At this time, it is preferable that the adaptive filter 106 uses various block adaptive algorithms.

As described above, the echo canceller 10 receives a signal from the input buffer 402 storing the input signal and then carries out the echo cancellation operation on the basis of the buffer unit. Since the input buffer 402 is contained in the speech codec according to its standard, an additional transfer delay does not occur in the speech-quality enhancing apparatus 60 in accordance with the present invention.

Further, the DT detector 109 in the conventional echo canceller 10 shown in FIG. 1 analyzes various signal characteristics between signals and a correlation between them and then carries out a DT detection operation. In accordance with the embodiment of the present invention, a DT (Double Talk) detector 109 operates on the basis of the buffer unit and hence can stably carry out the DT detection operation.

One of the widely used detection methods is to use the correlation between signals. Basically, the method carries out an average calculation operation and carries out a detection operation on the basis of one sample using current and previous information items as in the conventional echo canceller 10 shown in FIG. 1. However, if the DT detector 109 of the echo canceller 10 operates on the basis of the buffer unit in accordance with the embodiment of the present invention, the DT detector 109 can take accurate information by carrying out the average calculation operation for input information and previous information corresponding to a size of one buffer.

As shown in FIG. 7, the echo canceller 10 can use the characteristic information items 421 to 426 of the speech signal needed for carrying out the echo cancellation operation without a special calculation operation. The characteristic information items of the speech signal represent all information items containing the LPC information 421 and 426, the pitch information 422 and 425, the codebook information 423 and 424 associated with the input signal 420 from the input buffer 402 and a signal inputted from a de-packetizer of the speech decompression module 44 shown in FIG. 6. Here, the above-described information items are produced within the speech codec.

The LPC information 421 and the pitch information 422 are inputted into the echo canceller 10 before an input signal stored in the input buffer 402 is outputted to the echo canceller 10. Since the pitch information, LPC information and gains associated with the speech signal are not abruptly changed, they can perform an important role as information needed for carrying out a signal analysis operation.

As shown in FIG. 7, the characteristic information of the speech signal can be directly inputted into the DT detector 109 and the adaptive filter 106 contained in the echo canceller 10. This is an example where the echo canceller 10 uses the characteristic-information items 421 to 426 of the speech signal provided by the speech codec.

In other words, the DT detector 109 of the echo canceller 10 produces correlation information between the input signal 420 from the input buffer 402 and the input signal 414 from the output buffer 413 to carry out an accurate DT detection operation. At this time, the DT detector 109 receives the LPC information 421 and 426 and the pitch information 422 and 425 associated with the speech signal from the speech compression and decompression modules 43 and 44 and then uses the information items as additional information to determine whether or not a speech signal exists. Thus, the DT detector 109 can correctly detect a DT.

Further, the adaptive filter 106 of the echo canceller 10 can determine the existence of a speech signal using only the input signal 420. The speech-quality enhancing apparatus 60 in accordance with the present invention can effectively determine the existence of a speech signal by allowing the adaptive filter 106 of the echo canceller 10 to utilize additional information (i.e., a codebook gain of the codebook information 423 and a pitch gain of the pitch information 422) provided from the speech compression module 43. Furthermore, the speech-quality enhancing apparatus 60 can determine the existence of a speech signal by analyzing a codebook gain of the codebook information 424, a pitch gain of the pitch information 425, etc.

Where the speech-quality enhancing apparatus 60 uses the speech compressor based on a variable rate, an operation of determining the existence of a speech signal associated with the input signal 414 from the output buffer 413 can be carried out on the basis of a decompression rate of the speech decompression module 44. Thus, the existence of a speech signal associated with the input signal 414 from the output buffer 413 can be easily determined using information of a received packet 408. The operation of determining the existence of a speech signal associated with the input signal 420 from the input buffer 402 can be carried out on the basis of a compression rate of the speech compression module 43. When the packet 407 shown in FIG. 6 is remotely transmitted to the opposite side, the operation of determining the existence of a speech signal in the packet 407 can be carried out by utilizing the result of a speech-signal determination for a signal received 20 msec beforehand.

In the speech-quality enhancing apparatus 60 in accordance with the present invention, the echo canceller 10 can carry out a reliable echo cancellation operation using various information items, associated with an input signal, provided by the speech codec (containing the speech compression and decompression modules 43 and 44). The information items, associated with the input signal, provided by the speech codec are necessarily required for a standard speech coding operation. Thus, an additional transfer delay does not occur in the configuration of the present invention.

Where the echo canceller 10 is integrated and operated within the speech-quality enhancing apparatus 60 in contrast with the conventional independent apparatus, this case's merits are not limited to the above-described embodiments. Further, those skilled in the art will appreciate that the information items provided by the speech codec can be variously used.

In order for the echo canceller 10 to appropriately operate, a coefficient update operation associated with the adaptive filter 106 is carried out when a speech signal is contained in the input signal 414 from the output buffer 413 and no speech signal is contained in the input signal 420 from the input buffer 402, that is, when a single talk is performed. Thus, the echo canceller 10 analyzes the input signals and determines the existence of a speech signal. A result of the analysis and determination can be provided to the noise canceller 20 and the level controller 30 so that they can use the result of the analysis and determination.

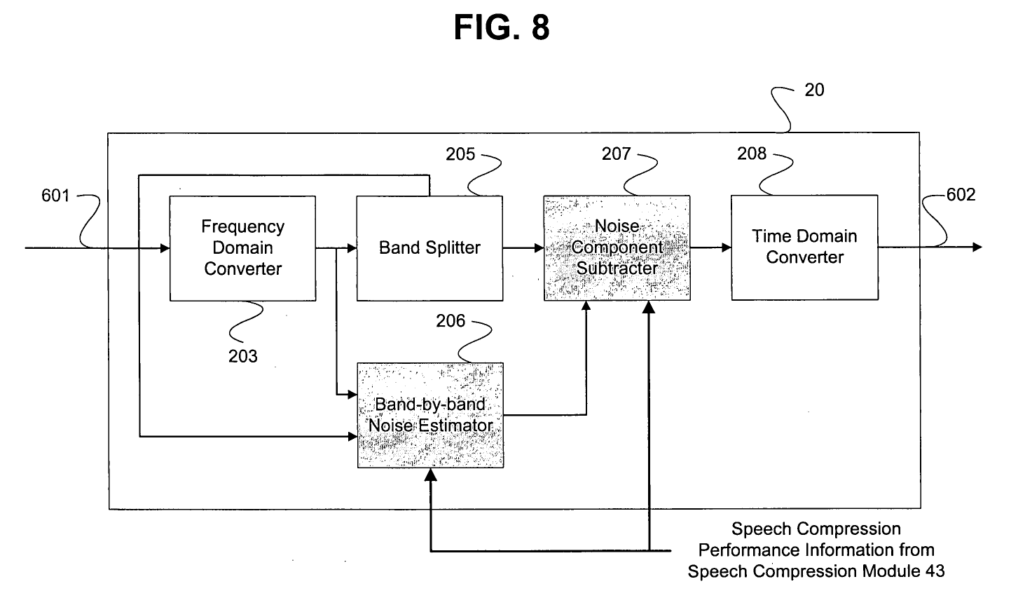

FIG. 8 is a block diagram illustrating a detailed structure of the noise canceller 20 contained in the speech-quality enhancing apparatus 60 in accordance with the present invention. Referring to FIG. 8, the noise canceller 20 carries out an operation of canceling noise components from the input signal 601 based on the buffer unit that is received from the echo canceller 10, and then outputs a signal 602 based on the buffer unit in which the noise components are cancelled. The noise canceller 20 receives a signal on the basis of the buffer unit as in the operation of the echo canceller 10, and can simultaneously use various information items, such that a frequency conversion operation, etc. can be effectively carried out.

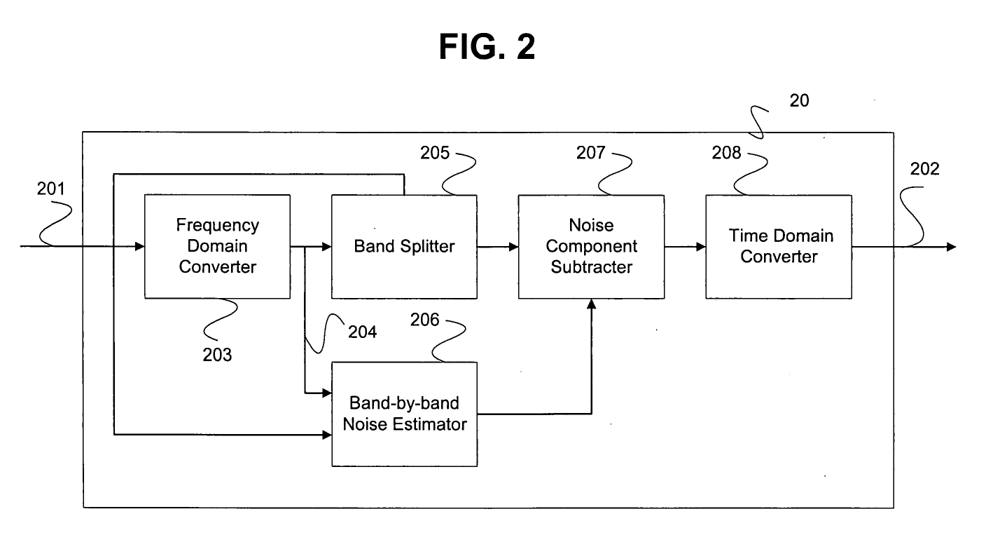

When the noise canceller 20 of the present invention shown in FIG. 8 is compared with the conventional noise canceller 20 shown in FIG. 2, the conventional noise canceller 20 requires an internal buffering operation at a time of carrying out a frequency conversion operation by means of the frequency domain converter 203 and causes an additional transfer delay if a separate device for carrying out the buffering operation is installed, while the noise canceller 20 of the speech-quality enhancing apparatus 60 in accordance with the present invention does not cause an additional transfer delay by using the input buffer 402 of the speech codec and the input signal 601 of the noise canceller 20 corresponding to a previously buffered signal.

An operation of determining the existence of a speech signal from the input signal 601 of the noise canceller 20 can directly use the result of the operation of determining the existence of a speech signal from the input signal 420 of the echo canceller 10, such that a noise section can be predicted and noise components can be estimated.

As shown in FIG. 8, if a band-by-band noise estimator 206 and a noise component subtracter 207 receives the speech compression performance information 428 produced by the speech compression module 43, operations of the band-by-band noise estimator 206 and the noise component subtracter 207 can be automatically adjusted and hence the performance of the speech compression module 43 can be enhanced.

The speech compression performance information 428 becomes a criterion needed for optimizing parameters associated with the operations of the band-by-band noise estimator 206 and the noise component subtracter 207. In other words, if the performance associated with the speech compression performance information 428 fed back from the speech compression module 43 is good, this means that the noise canceller 20 has appropriately performed the operation of canceling the noise components from the input signal 601. Meanwhile, if the performance associated with the speech compression performance information 428 is degraded, this means that the noise canceller 20 has not appropriately performed the operation of canceling the noise components from the input signal 601. Thus, the parameters associated with the band-by-band noise estimator 206 and the noise component subtracter 207 of the noise canceller 20 are adjusted according to the speech compression performance information 428 so that the performance of the speech compression module 43 can be enhanced.

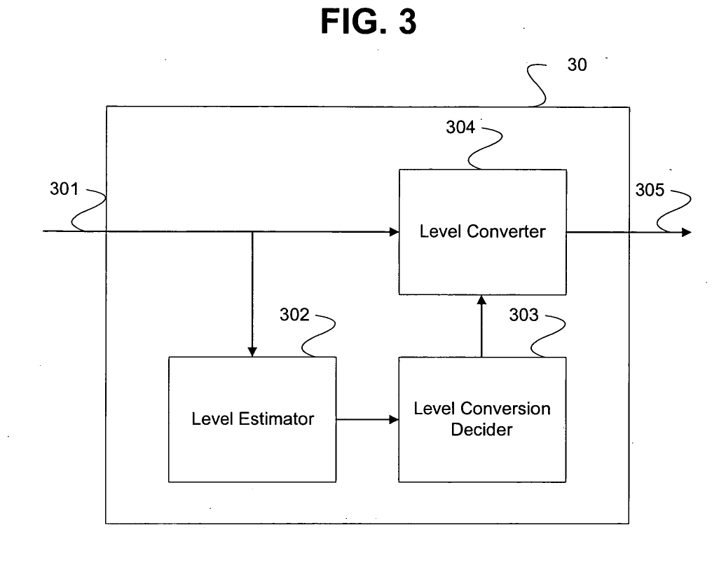

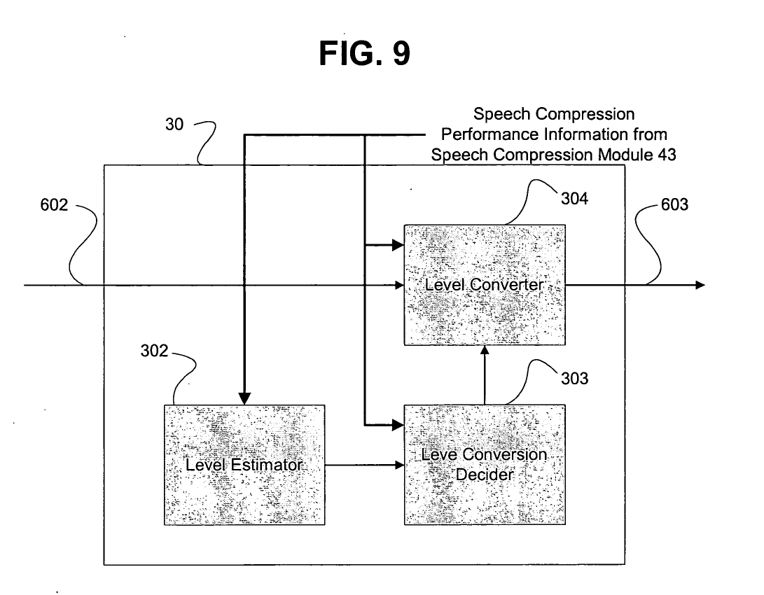

FIG. 9 is a block diagram illustrating a detailed structure of the level controller 30 contained in the speech-quality enhancing apparatus 60 in accordance with the present invention. The level controller 30 of the present invention shown in FIG. 9 is different from the conventional level controller 20 shown in FIG. 3 in that the level controller 30 of the present invention receives an output signal 602 based on the buffer unit from the noise canceller 20 and then converts a level of the output signal 602 into another signal level appropriate for the speech compression operation, thereby producing an output signal 603 based on the buffer unit. In this case, as every operation can be performed on the basis of the buffer unit without an additional transfer delay, the operation stability can be ensured.

As shown in FIG. 9, a level estimator 302, a level conversion decider 303 and a level converter 304 contained in the level controller 30 receive the speech compression performance information 428 as the result of the operation of the speech compression module 43. Then, the level controller 30 can determine its own performance so that the performance of the level controller 30 can be enhanced.

In other words, the level controller 30 receives the speech compression performance information 428 fed back from the speech compression module 43. If the performance associated with the speech compression performance information 428 is good, this means that a level of the input signal 602 has been appropriately adjusted so that the speech compressor can appropriately compress the input signal 602. Meanwhile, if the performance associated with the speech compression performance information 428 is degraded, this means that a level of the input signal 602 has been not appropriately adjusted. The level controller 30 can determine its own performance according to the speech compression performance information 428 so that the performance of the level controller 30 can be enhanced. If the level controller 30 operates independently of the speech compressor, the performance of the level adjustment cannot be verified.

In the speech-quality enhancing apparatus 60 in accordance with the present invention, the level controller 30 utilizes information items (e.g., a result of the quantization of codebook and pitch gains, energy of a decompression error signal to which a weight value is applied, performance of the speech compressor, etc.) to analyze its performance and can enhance its performance using a result of the analysis.

As apparent from the above description, the present invention provides an apparatus and method for enhancing speech quality in digital communications, which can integrate an echo canceller, noise canceller, level controller and speech codec. The present invention can provide advantageous effects as in the following.

First, the present invention can integrate the echo canceller, noise canceller, level controller and speech codec, independently developed and applied to a system, into a single unit in the digital communications so that the speech quality of the digital communications can be enhanced. In particular, as the speech codec is integrated and applied within the system, elements of the system can share various information items produced as results of operations, and operation performances can be enhanced using the information items.

Second, the present invention removes a repeat calculation operation independently performed in conventional devices by integrating the system's elements for enhancing speech quality in the digital communications, such that a cost-effective system can be simply implemented.

Third, the present invention can manage, using one buffer, input signals needed for carrying out speech quality enhancing operations of the system's elements in the digital communications, and can perform every operation in a unit of a buffer without an additional transfer delay. Thus, a total transfer delay time can be reduced, and each function performance can be enhanced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for enhancing speech quality in digital communications, comprising:
an input buffer for storing a sum signal of a first input signal to be transmitted and an echo signal generated from a received second input signal at a predetermined time interval;
an echo canceller for receiving the sum signal based on a unit of a buffer from the input buffer, canceling the echo signal from the sum signal, and outputting the first input signal;
a noise canceller for receiving the first input signal based on the buffer unit from the echo canceller, and canceling a noise from the first input signal;
a level controller for receiving the first input signal based on the buffer unit from the noise canceller, and adjusting a level of the first input signal; and
a speech compression module for receiving the first input signal based on the buffer unit from the level controller, converting the first input signal into a digital signal, and compressing the digital signal.

2. The apparatus as set forth in claim 1, wherein the speech compression module converts the first input signal into the digital signal, compresses the digital signal at a variable rate, determines whether a speech signal exists within the first input signal in a compression operation, generates speech-signal determination information, and outputs the speech-signal determination information to the echo canceller.

3. The apparatus as set forth in claim 1, wherein the speech compression module generates characteristic information associated with the first input signal in an operation of converting the first input signal into the digital signal, and outputs the characteristic information to the echo canceller.

4. The apparatus as set forth in claim 3,
wherein the speech compression module comprises an LPC (Linear Prediction Coding) analyzer, pitch analyzer and codebook analyzer associated with the first input signal, and operates on the basis of CELP (Code Excited Linear Prediction), and
wherein the characteristic information is configured by at least one of LPC information, pitch information and codebook information associated with the first input signal.

5. The apparatus as set forth in claim 4, wherein the speech compression module calculates a parameter quantization error associated with the characteristic information, calculate an error between the first input signal and a recovered first input signal to generate speech compression performance information, and outputs the speech compression performance information to at least one of the noise canceller and level controller.

6. The apparatus as set forth in claim 5, wherein the noise canceller comprises:
a band-by-band noise estimator for estimating a frequency band-by-band noise of the first input signal; and
a noise component subtracter for subtracting a noise component estimated by the band-by-band noise estimator from a frequency band-by-band signal of the first input signal,
wherein at least one of the noise component subtracter and band-by-band noise estimator receives the speech compression performance information and performs an operation of allowing the speech compression module to increase a compression performance.

7. The apparatus as set forth in claim 5, wherein the level controller comprises:
a level estimator for receiving the first input signal and estimating a speech signal level;
a level conversion decider for deciding a conversion level with the level estimated by the level estimator; and
a level converter for converting the speech signal level into the level decided by the level conversion decider,
wherein the level estimator, level conversion decider and level converter receive the speech compression performance information and determine level adjustment performance associated with the speech signal.

8. The apparatus as set forth in claim 1, further comprising:
a speech decompression module for receiving the digital signal and decompressing the digital signal into the second input signal; and
an output buffer for storing the second input signal at a predetermined time interval, the stored second input signal based on the buffer unit being outputted to the echo canceller.

9. The apparatus as set forth in claim 8, wherein the speech decompression module decompresses the digital signal into the second input signal at a variable rate, determines whether or not a speech signal exists within the second input signal in an operation of decompressing the digital signal into the second input signal, generates speech-signal determination information, and outputs the speech-signal determination information to the echo canceller.

10. The apparatus as set forth in claim 2 or 9, wherein the echo canceller comprises:
a DT (Double-Talk) detector for determining whether a speech signal exists within the first and second input signals;
an adaptive filter for predicting the echo signal according to a result of the determination from the DT detector;
an operator for producing a difference signal between the sum signal and the echo signal predicted from the adaptive filter; and
a non-linear processor for finally canceling a remaining echo signal from the difference signal,
wherein at least one of the DT detector and the adaptive filter receives the speech-signal determination information and uses the received speech-signal determination information as the result of the determination by the DT detector.

11. The apparatus as set forth in claim 8, wherein the speech decompression module outputs, to the echo canceller, characteristic information associated with the second input signal generated in an operation of decompressing the digital signal into the second input signal.

12. The apparatus as set forth in claim 11, wherein the speech decompression module comprises an LPC (Linear Prediction Coding) synthesizer, pitch synthesizer and codebook synthesizer associated with the second input signal, and operates on the basis of CELP (Code Excited Linear Prediction), and
wherein the characteristic information is configured by at least one of LPC information, pitch information and codebook information associated with the second input signal.

13. The apparatus as set forth in claim 4 or 12, wherein the echo canceller comprises:
a DT (Double-Talk) detector for determining whether a speech signal exists within the first and second input signals;
an adaptive filter for predicting the echo signal according to a result of the determination from the DT detector;
an operator for producing a difference signal between the sum signal and the echo signal predicted from the adaptive filter; and
a non-linear processor for finally canceling a remaining echo signal from the difference signal,
wherein at least one of the DT detector and the adaptive filter receives the speech-signal determination information and uses the received speech-signal determination information as additional information in the determination by the DT detector.

14. The apparatus as set forth in claim 8, wherein the echo canceller comprises:
a DT (Double-Talk) detector for determining whether a speech signal exists within the first and second input signals;
an adaptive filter for predicting the echo signal according to a result of the determination from the DT detector;
an operator for producing a difference signal between the sum signal and the predicted echo signal from the adaptive filter; and
a non-linear processor for finally canceling a remaining echo signal from the difference signal,
wherein the result of the determination from the DT detector is outputted into at least one of the noise canceller and level controller.

15. The apparatus as set forth in claim 1 or 8, wherein the predetermined time interval is within a range of 10 msec to 30 msec.

16. A method for enhancing speech quality in digital communications, comprising the steps of:
(a) storing a sum signal of a first input signal to be remotely transmitted and an echo signal generated from a remotely received second input signal at a predetermined time interval;
(b) receiving the sum signal based on a unit of a buffer, canceling the echo signal from the sum signal, and extracting the first input signal;
(c) receiving the first input signal based on the buffer unit, and canceling a noise from the first input signal;
(d) receiving the first input signal based on the buffer unit in which the noise is cancelled, and adjusting a level of the first input signal; and
(e) receiving the first input signal based on the buffer unit in which the level of the first input signal is adjusted, converting the first input signal into a digital signal, and compressing the digital signal.

17. The method as set forth in claim 16, wherein the step (a) comprises the step of receiving the second input signal from the digital signal, recovering a speech signal from the second input signal, and buffering and outputting the speech signal at the predetermined time interval.

18. The method as set forth in claim 17, wherein the step (a) comprises the step of generating characteristic information associated with the second input signal in an operation of recovering the speech signal from the second input signal, and
the step (e) comprises the step of generating characteristic information associated with the first input signal in an operation of converting the first input signal into the digital signal and compressing the digital signal.

19. The method as set forth in claim 18,
wherein at the step (a) the characteristic information is configured by at least one of LPC (Linear Prediction Coding) information, pitch information and codebook information associated with the second input signal, and
wherein at the step (e) the characteristic information is configured by at least one of LPC information, pitch information and codebook information associated with the first input signal.

20. The method as set forth in claim 18, wherein the step (b) comprises the step of determining whether a speech signal exists within the first and second input signals, predicting the echo signal according to a result of the determination, producing a difference signal by subtracting the predicted echo signal from the sum signal, and finally canceling a remaining echo signal from the difference signal,
wherein the characteristic information is received in an operation of determining the existence of the speech signal, and is used as additional information.

21. The method as set forth in claim 16,
wherein the step (a) comprises the step of determining whether a speech signal exists within the second input signal in an operation of recovering the speech signal from the second input signal at a variable rate, and generating speech-signal determination information, and
wherein the step (e) comprises the step of determining whether a speech signal exists within the first input signal in an operation of converting the first input signal into the digital signal and compressing the digital signal at a variable rate, and generating speech-signal determination information.

22. The method as set forth in claim 19, wherein the step (e) comprises the step of calculating a parameter quantization error associated with the characteristic information, and calculating an error between the first input signal and a recovered first input signal to generate speech compression performance information.

23. The method as set forth in claim 22, wherein the step (c) comprises the step of receiving the speech compression performance information to be used as additional information for estimating a frequency band-by-band noise of the first input signal, and canceling the noise from the first input signal so that speech compression performance can be enhanced.

24. The method as set forth in claim 22, wherein the step (d) comprises the step of receiving the speech compression performance information to be used as additional information for determining performance of adjusting a level of a speech signal contained in the first input signal.
